(19) United States
(12) Patent Application Publication
(10) Pub. No.: US 2017/0202395 A1
(43) Pub. Date: Jul. 20, 2017

(54) IGNITION DEVICE, PARTICULARLY FOR FORMING EMBERS FOR BARBECUES, OVENS AND THE LIKE

(71) Applicant: RINALDO LOMONACO, Montevarchi (IT)

(72) Inventor: Rinaldo LOMONACO, Montevarchi (IT)

(21) Appl. No.: 15/317,311

(22) PCT Filed: Feb. 24, 2015
(86) PCT No.: PCT/EP2015/053830

§ 371 Date: Dec. 8, 2016

(30) Foreign Application Priority Data
Jun. 12, 2014 (IT) AR2014A000037

(51) Int. Cl. A47J 37/07

(52) U.S. Cl. CPC A47J 37/079; A47J 37/0754

(57) ABSTRACT

An ignition device, particularly for forming embers for barbecues, ovens and the like, which has a supporting structure that defines a container body that is adapted to contain carbon-based fuel blocks, and at least one ignition region, which is arranged proximate to the carbon-based fuel blocks and is adapted to accommodate means of ignition of at least one of the carbon-based fuel blocks, the device further comprising air conveyance means which are associated with the container body and are functionally connected to air blower means for the forced oxygenation of the carbon-based fuel block that is already ignited, by way of the conveyance of a fluid stream of air in the direction thereof through the container body, with consequent cascade ignition of the other carbon-based fuel blocks that are adjacent to the carbon-based fuel block that is already ignited.

The present invention relates to an ignition device, particularly for forming embers for barbecues, ovens and the like.

As is known, in order to obtain embers, adapted for example to feed ovens or barbecues used for cooking food, with the devices known today, it is necessary to perform operations that can take up to an hour and even longer.

In more detail, the stoker has to prepare the combustible material, wood or slack in general, in such a manner that, once lit by way of an igniter, it starts to burn locally and, thanks to the natural draw that the combustion generates, the combustion propagates to all the combustible material.

Quite often, the complete ignition of the combustible material requires continuous intervention from the stoker who has to continually supply the embers with a flow of air, for example with fans, and/or reposition them so that they are optimally fanned.

Such operations, which as previously mentioned require a lot of time, are operations that cannot be effectively carried out by just anyone.

In fact, the stoker is required to have a certain level of experience with fire that not everyone, especially in a more household setting, can achieve.

The aim of the present invention consists in providing an ignition device that makes it possible to rapidly obtain embers, particularly embers for barbecues, ovens and the like, completely autonomously, i.e. without requiring the intervention or supervision of an operator.

Within this aim, an object of the present invention consists in providing an ignition device that can be easily used by anyone.

Another object of the present invention consists in providing an ignition device that offers the widest assurances of operation and reliability.

A further object of the present invention is to provide an ignition device that is made with materials and components that are easily sourced on the market in such a manner as to keep production costs low.

This aim and these and other objects which will become better apparent hereinafter are achieved by an ignition device, particularly for forming embers for barbecues, ovens and the like, which comprises a supporting structure that defines a container body that is adapted to contain carbon-based fuel blocks, and at least one ignition region, which is arranged proximate to said carbon-based fuel blocks and is adapted to accommodate means of ignition of at least one of said carbon-based fuel blocks, characterized in that it comprises air conveyance means which are associated with said container body and are functionally connected to air blower means for the forced oxygenation of said at least one of said carbon-based fuel blocks that is already ignited, by way of the conveyance of a fluid stream of air in the direction of said at least one of said carbon-based fuel blocks that is already ignited through said container body, with consequent cascade ignition of the other said carbon-based fuel blocks that are adjacent to said at least one of said carbon-based fuel blocks that is already ignited.

Further characteristics and advantages of the invention will become better apparent from the detailed description of a preferred, but not exclusive, embodiment of an ignition device, particularly for forming embers for barbecues, ovens and the like, according to the invention, which is illustrated by way of non-limiting example in the accompanying drawings, wherein:

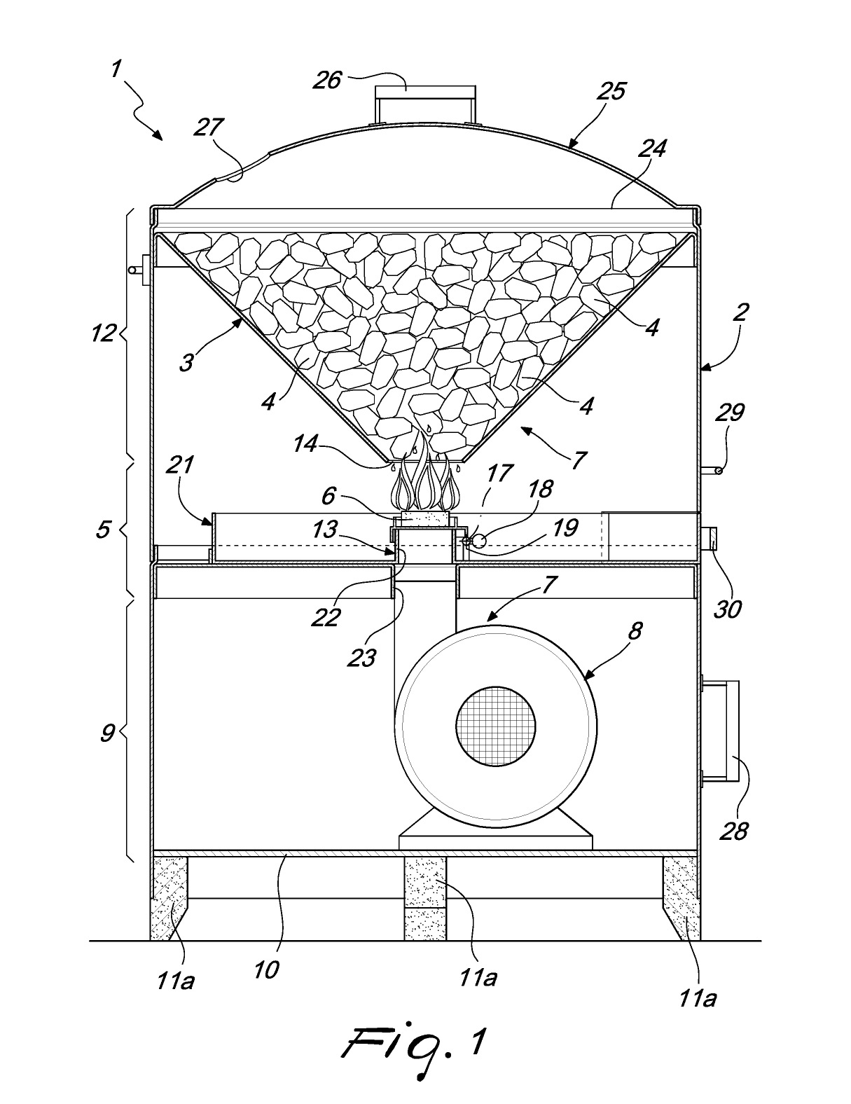

FIG. 1 is a schematic side view of an ignition device, particularly for forming embers for barbecues, ovens and the like, according to the invention, during the step of ignition;

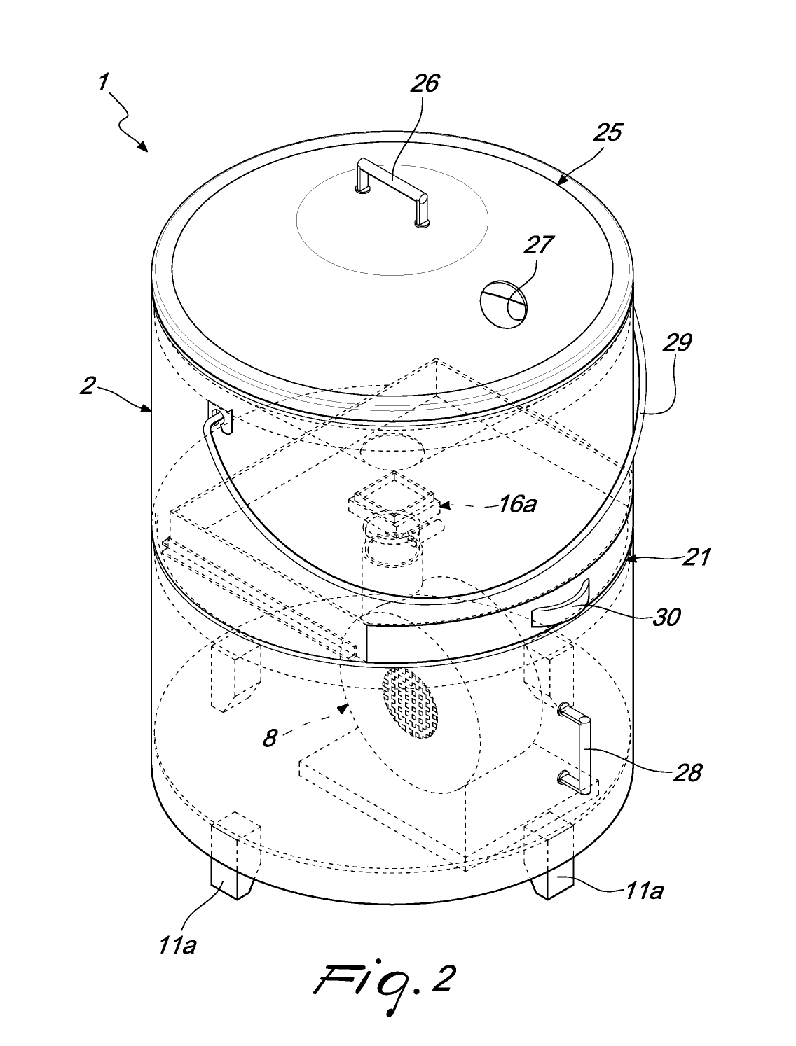

FIG. 2 is a perspective view of the ignition device shown in FIG. 1;

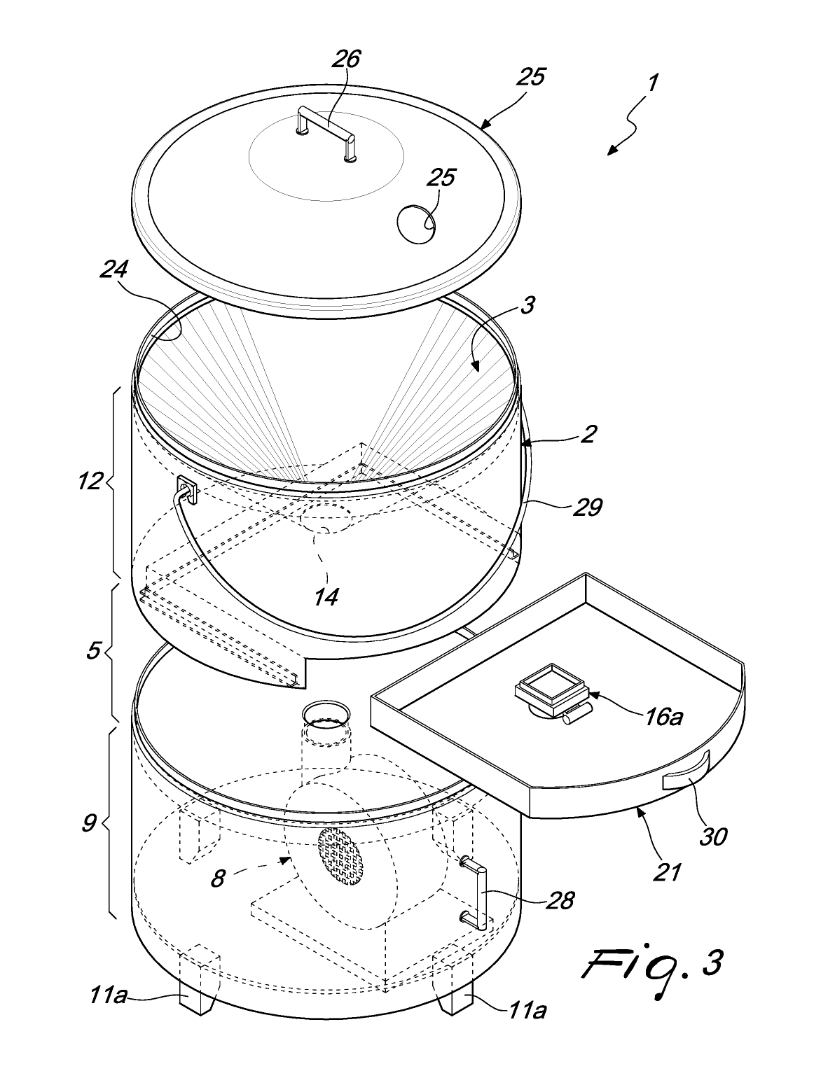

FIG. 3 is an exploded perspective view of the ignition device shown in FIGS. 1 and 2;

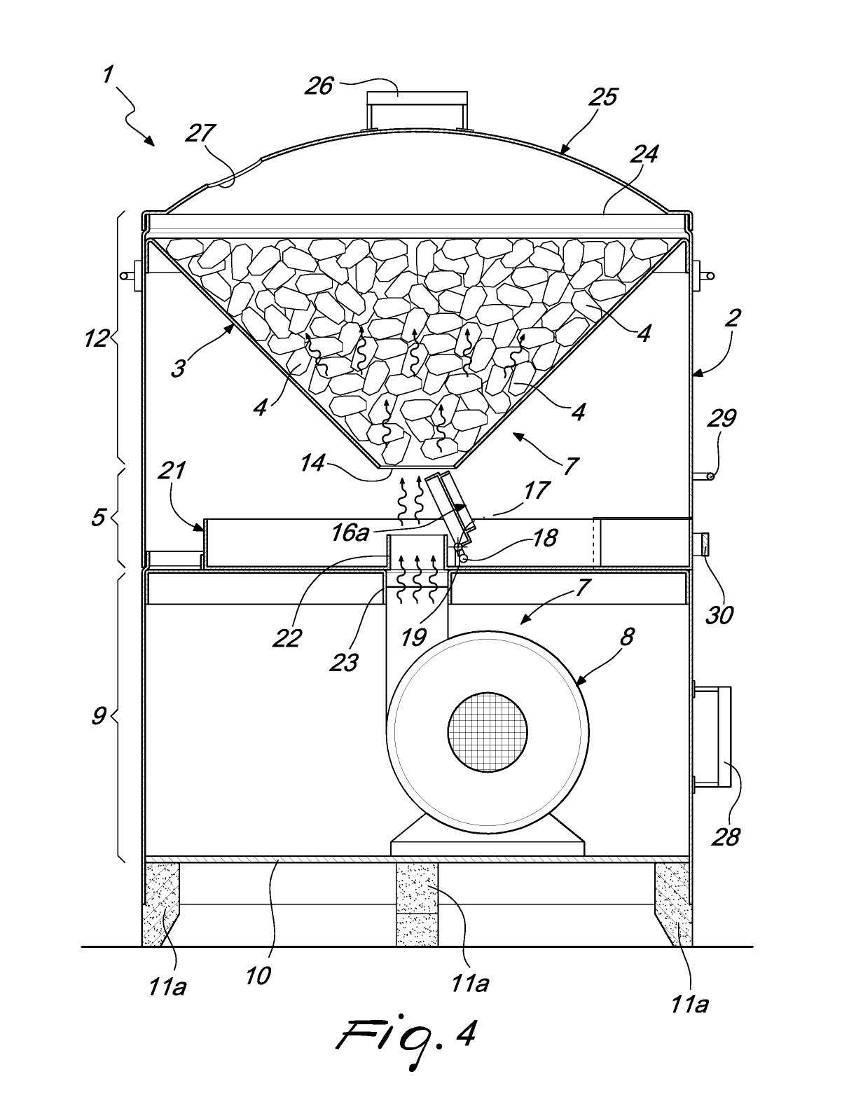

FIG. 4 is a schematic side view of the ignition device shown in FIGS. 1 to 3, during the step of oxygenation;

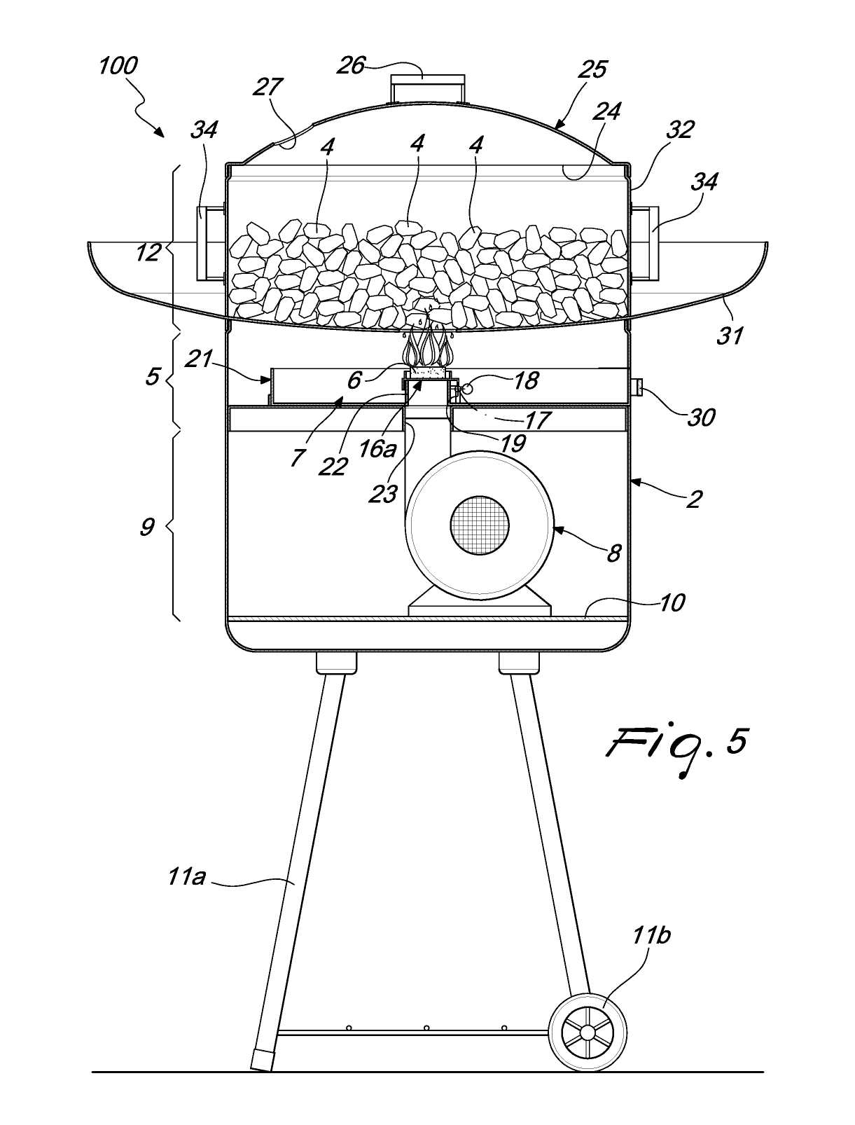

FIG. 5 is a schematic side elevation view of a barbecue that comprises the ignition device, according to the invention, shown during the step of ignition;

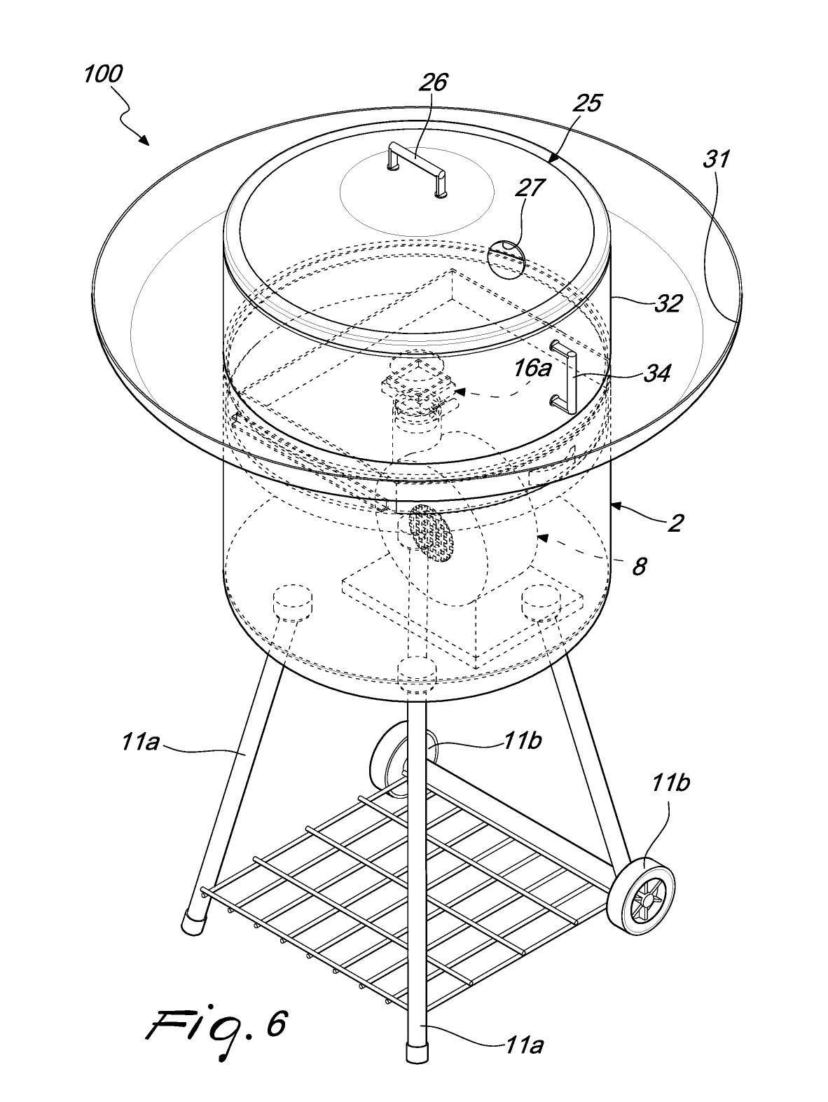

FIG. 6 is a perspective view of the barbecue shown in FIG. 5;

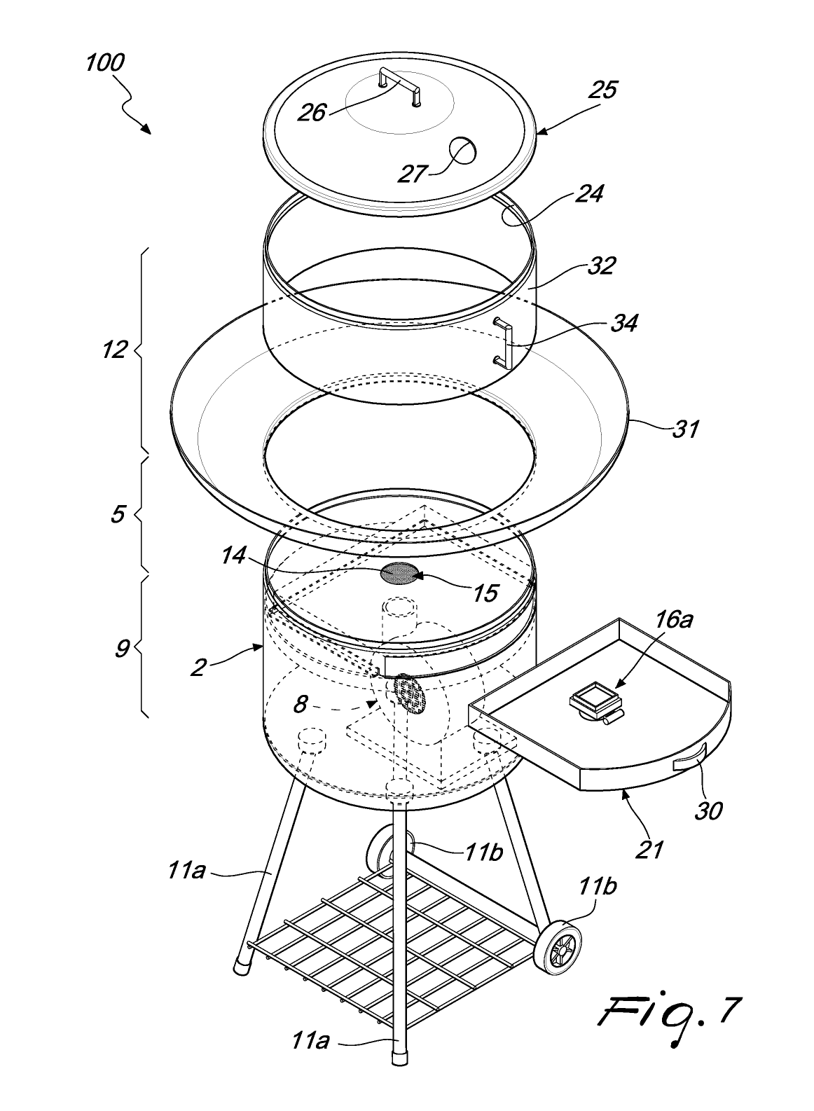

FIG. 7 is an exploded perspective view of the barbecue shown in FIGS. 5 and 6;

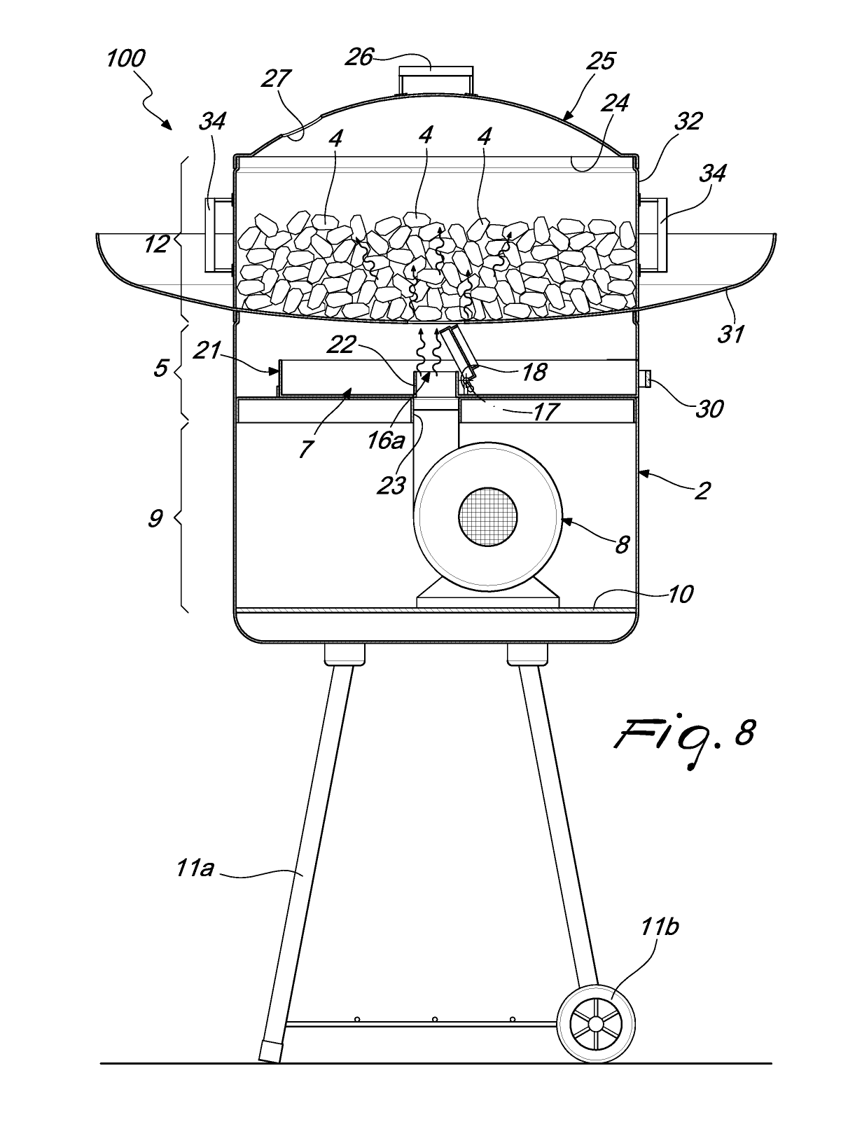

FIG. 8 is a schematic side elevation view of the barbecue shown in FIGS. 5 to 7, during the step of oxygenation;

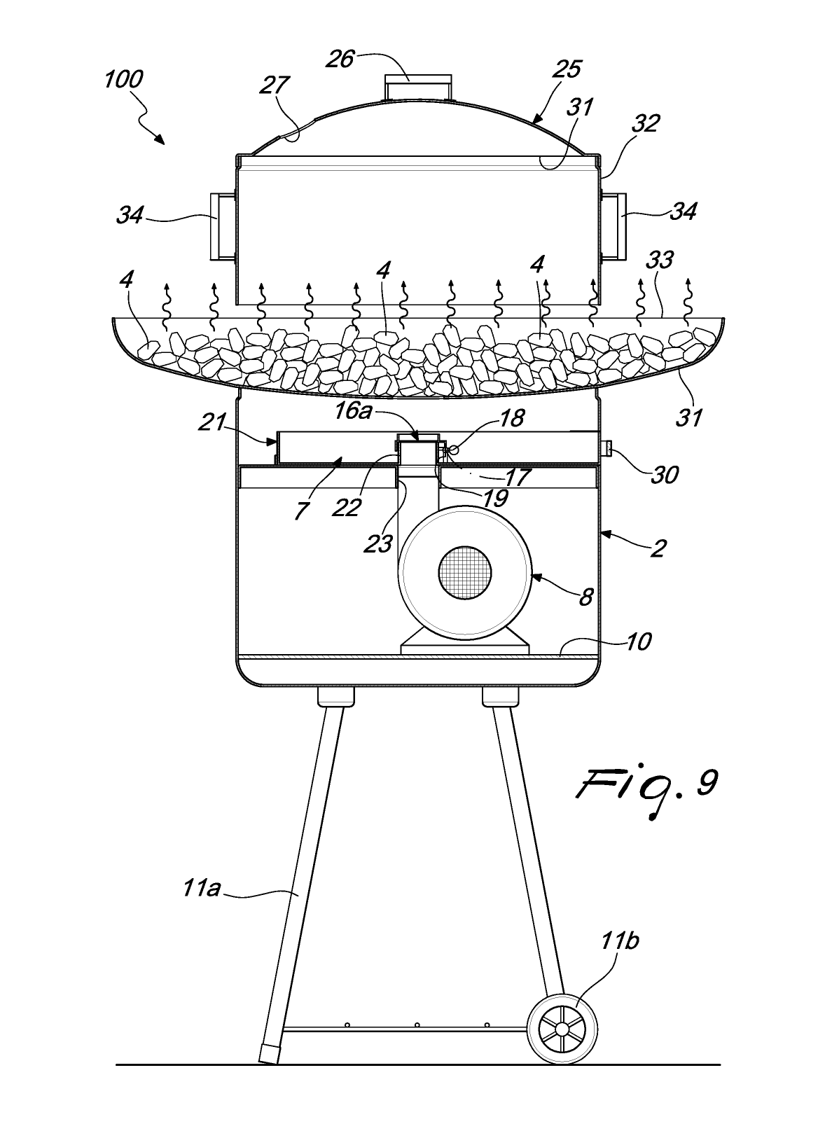

FIG. 9 is a schematic side elevation view of the barbecue shown in FIGS. 5 to 8, during the step of use;

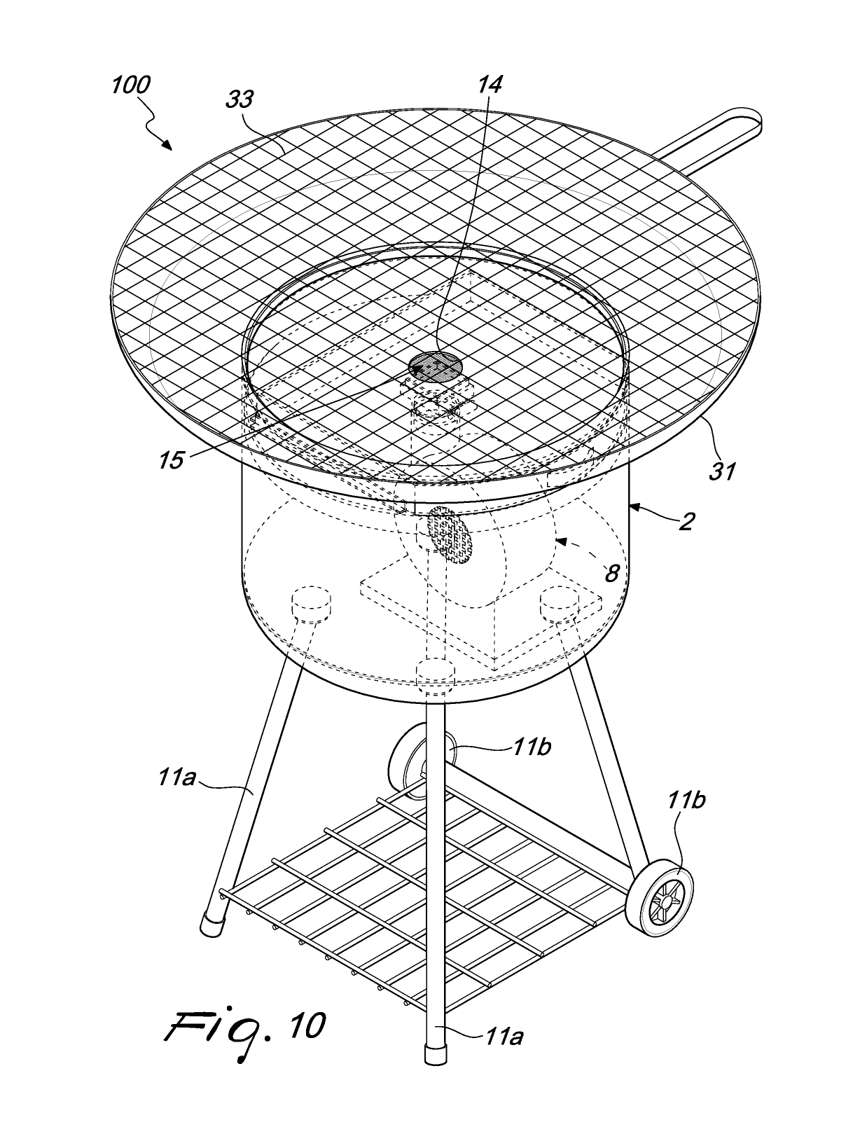

FIG. 10 is a perspective view of the barbecue shown in FIGS. 5 to 9, during the step of use;

FIG. 11 is a perspective view of the component of the ignition device, according to the invention, which defines the ignition region;

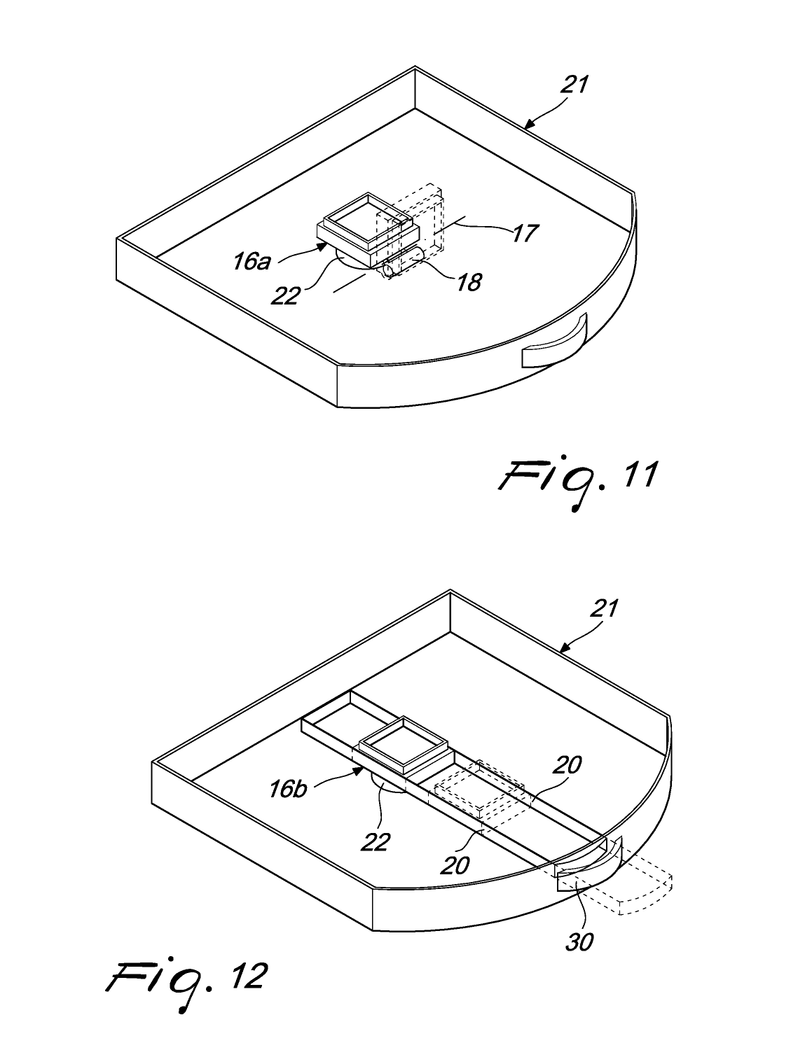

FIG. 12 is a perspective view of a variation of the component shown in FIG. 11.

With reference to the figures, the ignition device, particularly for forming embers for barbecues, ovens and the like, which is generally designated with the reference numeral 1, comprises a supporting structure 2 that defines a container body 3 that is adapted to contain carbon-based fuel blocks 4, for example slack or wood in general, and at least one ignition region 5, which is arranged proximate to the carbon-based fuel blocks 4 and is adapted to accommodate means of ignition of at least one of the carbon-based fuel blocks 4.

In more detail, in the embodiment proposed, the means of ignition comprise firelighter material 6, such as for example synthetic cubes based on kerosene, liquid kerosene and sticks of wood, or elements that are adapted to burn easily.

As an alternative or in addition to the firelighter material 6 mentioned above, the means of ignition can comprise an electric ignition assembly, which is constituted for example by one or more electric elements, one or more electric glow plugs of various materials, shapes and sizes.

Such electric ignition assembly can be arranged proximate to the carbon-based fuel blocks 4, for their direct ignition, or proximate to the firelighter material 6, so as to ignite the latter and as a consequence cause the ignition of the carbon-based fuel blocks 4 by way of the combustion of the firelighter material 6.

For example, in the embodiment proposed, such electric ignition assembly could be arranged proximate to firelighter material 6 or, in the absence of the latter, at the base of the container body 3.

According to the invention, air conveyance means 7 are provided which are associated with the container body 3 and are functionally connected to air blower means 8, which comprise for example an electric fan powered by direct or alternating current according to whether the ignition device 1 is intended for household use or in environments without a mains electricity supply and therefore requiring a battery power supply, for the forced oxygenation of the carbon-based fuel block or blocks 4 that is or are already ignited, by way of the conveyance of a fluid stream of air in the direction thereof through the container body 3, with consequent cascade ignition of the other carbon-based fuel blocks 4 that are adjacent to the block or blocks that is or are already ignited.

To complete the ignition device 1, management and control means, not shown for the sake of graphical simplicity, are provided which comprise timer means that are adapted to shut down the blower means 8 and the electric ignition assembly, if provided, after preset periods of operation.

In more detail, such management and control means can comprise a voltage variator or regulator which is adapted to manage the speed of the blower means.

In this way, it is possible to reactivate the embers in the event of the coal fading by managing the flow of air, for example with a controlled speed, and contain the egress of ash.

Moreover, by adjusting the intensity of the blown air, it is possible to safely control the flames produced by the carbon-based fuel blocks 4 in the step of ignition if it is necessary to open the cover or to check the blocks.

Finally, by using a speed regulator with a remote control, it is possible to switch on and off the blower means without even requiring the intervention in person of the user.

The ignition device 1, as will be better described below, is therefore an accessory that is adapted to obtain embers in a short time, about ten minutes, completely autonomously and therefore without the supervision or intervention of the user, except for intervening to switch on the blower means 8.

The ignition device 1 can be used in a culinary environment, both outdoors and indoors, in this case for the preparation of embers to be used for cooking, at the same time becoming an item of furniture in its own right.

As a consequence, the ignition device 1 proper can assume different aesthetic forms according to the aesthetic tastes of the user and/or it can be integrated in conventional cooking devices, such as for example barbecues and the like.

In the embodiment proposed, with particular reference to FIGS. 1 to 4, the supporting structure 2 has a substantially tower-like geometry with a circular cross-section divided into at least one lower compartment 9, which defines a ground resting base 10 that is provided for example with feet 11a or wheels 11b, and which accommodates the blower means 8, and an upper compartment 12, which accommodates the container body 3.

The lower compartment 9 and the upper compartment 12 are mutually connected by way of an internal smokestack 13 extending from the discharge port of the blower means 8 and ending proximate to a lower opening 14 of the container body 3, which is conveniently provided with a grille for holding back embers 15, in such a manner as to allow the flow of the fluid stream of air generated by the blower means 8 while preventing the falling of the embers formed from the carbon-based fuel blocks 4 and the falling of the carbon-based fuel blocks 4 themselves.

In this way, the container body 3 defines part of the conveyance means 7.

Furthermore, defined between the lower compartment 9 and the upper compartment 12 is the ignition region 5 in which to place the firelighter material 6.

In order to enable the correct oxygenation of the carbon-based fuel blocks 4 and thus the correct ignition thereof, in the ignition region 5 there is a plate 16a that is adapted to accommodate the firelighter material 6 and which can move between an active position, in which it obstructs the internal smokestack 13, and an inactive position, in which the internal smokestack 13 is free from the plate 16a.

In the embodiment proposed, as clearly shown in FIG. 11, the plate 16a is hinged laterally to the internal smokestack 13 in such a manner as to rotate about a pivoting axis 17 that is arranged externally to the internal smokestack 13 and is substantially perpendicular to the fluid stream of air that passes through the smokestack 13 in order to move the plate 16a between the active position and the inactive position.

Advantageously, the plate 16a is provided with a counterweight 18 and with a stroke limiter 19 of the mechanical type in such a manner as to make it perform rotations about the pivoting axis 17 through less than 90° so that the plate 16a can move from the active position to the inactive position, under the action of the thrust of the fluid stream of air, and can move from the inactive position to the active position, by gravity in the absence of the fluid stream of air.

As shown in FIG. 12, there can be a variation 16b of the plate 16a in which the plate is associated slideably with the internal smokestack 13 along a guide 20 that is substantially perpendicular to the fluid stream of air for the manual movement thereof between the active position and the inactive position.

Advantageously, the ignition region 5 is delimited inside an ash collection drawer 21 of the type that can be extracted from the supporting structure 2.

Conveniently, the plate 16a and its variation 16b described above are integral in translational motion with the ash collection drawer 21, and the internal smokestack 13 is defined by two smokestack portions 22 and 23 which are mutually aligned, one of which is integral with the ash collection drawer 21 and one of which is integral with the lower compartment 9.

In the proposed embodiment of the ignition device 1, shown in FIGS. 1 to 4, the container body 3 has a geometry with a substantially divergent cross-section, along the direction of crossing of the fluid stream of air generated by the blower means 8, for example like an upside-down truncated cone, in such a manner that the ignition of the several layers of the carbon-based fuel blocks 4 occurs in sequence, one after the other, rising according to an inverted pyramidal scheme.

Conveniently, the container body 3 has an upper opening 24, which is arranged at the opposite side with respect to the lower opening 12, for filling and emptying the container body 3 with the carbon-based fuel blocks 4.

To complete the ignition device 1, there can be a cover 25 of the container body 3 for closing the upper opening 24 in such a manner as to limit heat dissipation inside the container body 3.

The cover 25 can be provided with a handle 26 and with a ventilation opening 27.

In addition there can be first handles 28 and 29 which are associated externally with the supporting structure 2 for lifting and tipping the ignition device 1 for the egress of the embers obtained from the combustion of the carbon-based fuel blocks 4.

In more detail, a first lower handle 28 is defined at the lower compartment 9 and a first upper handle 29 is defined at the upper compartment 12.

As shown in the figures, both of the handles 28 and 29 are defined on the side with the ash collection drawer 21, which is also provided with a handle 30, so as to prevent the egress thereof by gravity during the tipping of the ignition device 1.

In more detail, the lower handle 28 is of the fixed type and the upper handle 29 is of the arc-shaped “bucket handle” type, which is pivoted to the supporting structure 2 at its top.

As already mentioned previously, the ignition device 1 thus described can be used for the rapid production of embers or it can be integrated in conventional cooking devices, such as for example barbecues and the like.

In an example, which is illustrated in FIGS. 5 to 10, the ignition device 1 described above can be integrated with a barbecue 100 in which the upper compartment 12 comprises a first portion 31, which is substantially plate-shaped and is associated integrally with the lower compartment 9, and a second portion 32, which has a cylindrical geometry, is open on both sides, and can be arranged in a detachable manner centrally to the first portion 31 in order to remove it after the embers have been obtained from the combustion of the carbon-based fuel blocks 4.

In this way, the whole that is made up of the base of the first portion 31, which can also be provided with a cooking grille 33, and of the side walls of the second portion 32, define the container body 3.

To complete the barbecue 100, the second portion 32 can have second handles 34 which are adapted to its removal.

Operation of the ignition device 1, particularly for forming embers for barbecues, ovens and the like, can be easily intuited from the foregoing description.

With reference to the figures, once the container body 3 has been filled with the carbon-based fuel blocks 4, the firelighter material 6 is then positioned at the preset points of the ignition region 5, igniting them.

Such ignition can occur manually, by way of igniting them before positioning them or by way of a flame operated from a certain distance, or it can occur completely automatically by way of the electric ignition assembly, if provided.

Alternatively, if such electric ignition assembly is arranged proximate to the carbon-based fuel blocks 4 and if the latter are such as to self-ignite by way of contact with a high-temperature source, the ignition of the carbon-based fuel blocks 4 can occur autonomously without the use of firelighter material 6.

In this way it is possible to program the delayed ignition of the carbon-based fuel blocks 4 by way of the timer means that are responsible for the operation of the electric ignition assembly.

After a few necessary minutes for the complete ignition of the carbon-based fuel blocks 4 that are adjacent to the ignition region 5, a preset time after which the electric ignition assembly, if provided, is automatically deactivated by the above-mentioned timer means, the user has to merely activate the blower means 8 so that the combustion of the carbon-based fuel blocks 4 that are already burning will propagate autonomously to the others as well.

As previously described, timer means, if provided, can switch off the blower means 8 after a preset period.

At this point, if the ignition device 1 is not integrated with a barbecue 100, the embers can be considered ready and they can be tipped into a brazier for cooking foods.

In practice it has been found that the ignition device, particularly for forming embers for barbecues, ovens and the like, according to the present invention, fully achieves the set aim and objects, in that it makes it possible to obtain, in a short time and completely autonomously, i.e. without the constant supervision of a stoker and without requiring particular expertise on fire, embers that are completely fanned and ready for use, simply and rapidly and offering the widest assurances of operation and reliability.

Another advantage of the ignition device according to the invention consists in that the carbon-based fuel blocks are fanned completely, right down to the core, a phenomenon that is hard to achieve with conventional devices.

Another advantage of the ignition device according to the invention consists in that, as needed, small quantities of embers can be formed, even just a kilogram or a few hundred grams, in order to cook small amounts of food, unlike what occurs with conventional devices with which, usually, this is not done owing to the lengthy time required to ignite the carbon-based fuel blocks.

Another advantage of the ignition device according to the invention consists in that it is possible to ignite the carbon-based fuel blocks outdoors even in unfavorable environmental conditions, as on very windy days.

Another advantage of the ignition device according to the invention consists in that the embers produced in the container body can be used at another time after production, by keeping them hot for the time required without heat dispersion.

Another advantage of the ignition device according to the invention consists in that, although the heat power of the carbon-based fuel blocks fades during their use owing to oil and/or melted fat that drips down during the cooking of the food, the same carbon-based fuel blocks can be fed back in, becoming re-oxygenated, regaining their original cooking characteristics, thus avoiding the use of new carbon-based fuel blocks.

Another advantage of the ignition device according to the invention consists in that with not much firelighter material it is possible to easily light very large braziers, with a considerable cost saving.

Another advantage of the ignition device according to the invention consists in that thanks to the electric ignition assembly it is possible to program the delayed ignition of the embers in order to have them ready at a preset time and obtain a form of low cost ignition without polluting the embers with kerosene-based firelighter material or the like.

The ignition device, particularly for forming embers for barbecues, ovens and the like, thus conceived, is susceptible of numerous modifications and variations, all of which are within the scope of the appended claims.

For example, as well as in barbecues, the device can be integrated or used in wood-fired ovens, such as those used for cooking farinaceous products.

Moreover, all the details may be substituted by other, technically equivalent elements.

In practice the materials employed, and the contingent dimensions and shapes, may be any according to requirements and to the state of the art.

The disclosures in Italian Patent Application No. AR2014A000037 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1. An ignition device, particularly for forming embers for barbecues, ovens and the like, the ignition device comprising:
a supporting structure that defines a container body that is adapted to contain carbon-based fuel blocks,
at least one ignition region, which is arranged proximate to said carbon-based fuel blocks and is adapted to accommodate means of ignition of at least one of said carbon-based fuel blocks,
air conveyance means which are associated with said container body and are functionally connected to air blower means for a forced oxygenation of said at least one of said carbon-based fuel blocks that is already ignited, by way of the conveyance of a fluid stream of air in the direction of said at least one of said carbon-based fuel blocks that is already ignited through said container body, with consequent cascade ignition of the other said carbon-based fuel blocks that are adjacent to said at least one of said carbon-based fuel blocks that is already ignited.

2. The ignition device of claim 1, wherein said means of ignition comprise either or both firelighter material and an electric ignition assembly which is arranged proximate to either or both said at least one carbon-based fuel blocks, for its direct ignition, and said firelighter material, for the ignition of said at least one of said carbon-based fuel blocks by way of the combustion of said firelighter material.

3. The ignition device of claim 1, wherein the ignition device comprises management and control means which comprise timer means adapted to activate and switch off said blower means and/or said electric ignition assembly after preset periods of operation.

4. The ignition device of claim 1, wherein said supporting structure has a substantially tower-like geometry divided into at least one lower compartment, which defines a ground resting base and accommodates said blower means, and an upper compartment, which accommodates said container body, said lower compartment and said upper compartment being mutually connected by way of an internal smokestack that extends from the discharge port from said blower means and ends proximate to a lower opening of said container body in such a manner as to allow the flow of said fluid stream of air generated by said blower means, between said lower compartment and said upper compartment there being said at least one ignition region, and said container body defining part of said conveyance means.

5. The ignition device of claim 1, wherein the ignition device comprises, at said at least one ignition region, a plate that is adapted to accommodate said firelighter material and can move between an active position, in which said plate obstructs said internal smokestack, and an inactive position, in which said internal smokestack is free from said plate.

6. The ignition device of claim 5, wherein said plate is hinged laterally to said internal smokestack in such a manner that said plate rotates about a pivoting axis that is arranged outside said internal smokestack and substantially at right angles to said fluid stream of air for the rotation of said plate about said pivoting axis between said active position and said inactive position.

7. The ignition device according of claim 6, wherein said plate is provided with a stroke limiter of the mechanical type, in such a manner that said plate can perform rotations about said pivoting axis through less than 90° in such a manner that said plate can move from said active position to said inactive position under the action of the thrust of said fluid stream of air and can move from said inactive position to said active position by gravity in the absence of said fluid stream of air.

8. The ignition device of claim 5, wherein said plate is associated slideably with said internal smokestack along a guide that is substantially perpendicular to said fluid stream of air for the manual movement of said plate between said active position and said inactive position.

9. The ignition device of claim 1, wherein said at least one ignition region is delimited inside an ash collection drawer of the type that can be extracted from said supporting structure, said plate being integral in translation with said ash collection drawer and said internal smokestack being defined by two smokestack portions that are mutually aligned, one of which is integral with said ash collection drawer and one of which is integral with said lower compartment.

10. The ignition device of claim 1, wherein said container body has a geometry with a substantially divergent cross-section, along the direction of crossing of said fluid stream of air generated by said blower means, said container body having an upper opening, arranged on the opposite side with respect to said lower opening, for filling and emptying said container body with said carbon-based fuel blocks.

11. The ignition device of claim 1, wherein the ignition device comprises a cover of said container body for closing said upper opening in such a manner as to limit heat dissipation within said container body.

12. The ignition device according of claim 1, wherein the ignition device comprises first handles that are associated externally with said supporting structure for lifting and tipping said ignition device for the egress of the embers obtained from the combustion of said carbon-based fuel blocks.

13. A barbecue comprising the ignition device of claim 1.

14. The of claim 13, wherein said upper compartment comprises a first portion, which is substantially plate-shaped and is associated integrally with said lower compartment, and a second portion, which has a cylindrical geometry, is open on both sides and can be arranged in a detachable manner centrally to said first portion in order to remove it once embers have been obtained from the combustion of said carbon-based fuel blocks, the base of said first portion and the side walls of said second portion defining said container body.
